(19) United States
(12) Patent Application Publication
(10) Pub. No.: US 2019/0005057 A1
(43) Pub. Date: Jan. 3, 2019

(54) Methods and Devices for File Folder Path Identification and File Folder Cleaning

(71) Applicant: Beijing Kingsoft Internet Security Software Co., Ltd., Beijing (CN)

(72) Inventor: Guoqiang JIAO, Beijing (CN)

(21) Appl. No.: 15/735,916

(22) PCT Filed: Aug. 12, 2016
(86) PCT No.: PCT/CN2016/094953

§ 371 Date: Dec. 12, 2017

(30) Foreign Application Priority Data
Jun. 15, 2015 (CN) 201510328958.8

(51) Int. Cl. G06F 17/30

(52) U.S. Cl. CPC G06F 17/30117; G06F 17/30303

(57) ABSTRACT

Embodiments of the present invention disclose methods and devices for folder path identification and folder cleaning. The method for folder path identification comprises: determining a set of folders to be processed (S101); obtaining a string corresponding to the path of each folder contained in the set of folders to be processed (S102); for the obtained string corresponding to the path of each folder, detecting whether there is a regular expression template matching the string in a preset regular expression template library (S103); if so, determining the detected regular expression template as a regular expression template of folder path corresponding to the string (S104); identifying a regular expression of the folder path corresponding to the string, based on the determined regular expression template (S105). Embodiments of the present application are applied to enable automatic identification of folder path and the cleaning of folders in electronic devices, improving the efficiency of identifying folder path in electronic devices and the efficiency of folders cleaning.

The present application claims priority to a Chinese patent application No. 201510328958.8, entitled “Methods and Devices for File Folder Path Identification and File Folder Cleaning” filed with the State Intellectual Property Office of People's Republic of China on Jun. 15, 2015, which is incorporated herein by reference in its entirety.

### TECHNICAL FIELD

The present invention relates to the technical field of folder identification, and more particularly to a method and a device for folder path identification and folder cleaning.

### BACKGROUND

With the development of smart phones and mobile phone software, there are more and more folders generated and more and more files stored in mobile phones. Normally, users will clean up junk files and search files and folders in mobile phones. In order to improve the efficiency of cleaning junk files and the efficiency of searching folders, etc., it is usually necessary to identify regular expressions corresponding to paths of folders in electronic devices.

A regular expression, also known as formal representation, conventional representation, is a concept in computer science. The regular expression uses a single string to describe, match a series of strings that conform to a certain syntax rule. In practical applications, a user can determine, according to a given regular expression and a string, whether the given string conforms to the filter logic of the regular expression; it is also possible to obtain a user-desired specific part from a given string by a given regular expression.

At present, a regular expression corresponding to the path of a folder in an electronic device is mainly identified manually, and the specific process is as follows: manually judging the path of each file in the electronic device, judging whether there is a regular expression template that matches this path of the folder in a preset regular expression template library; if so, manually identifying the regular expression corresponding to the this path of the folder based on the matched regular expression template. For example, it is needed to determine a regular expression for the folder path “/3548795”, first manually determine a regular expression template that matches this path in the preset regular expression template library, assuming that the matched regular expression template is [0-9] {s %}, wherein s % represents the length of a string; and further manually identify the regular expression “[0-9] {7}” corresponding to the folder path “3548795”.

However, there are lots of folders and thereby lots of paths of folders in an electronic device. Thus, it takes a long time and is less efficient to manually identify the paths of folders in electronic devices as described above.

### SUMMARY

The purpose of the present invention is to provide a method and a device for folder path identification so as to automatically identify folder path in an electronic device.

Another purpose of the present invention is to provide a method and a device for folder cleaning so as to automatically identify folder path and clean up the folders in an electronic device.

In order to achieve the purposes mentioned above, an embodiment of the present invention discloses a method for folder path identification, applied to an electronic device, wherein the method comprises:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of folder path corresponding to the string;

identifying a regular expression of the folder path corresponding to the string based on the determined regular expression template.

Optionally, the determining a set of folders to be processed, comprises:

determining each grade of folders in the electronic device as a set of folders to be processed respectively.

Optionally, determining a set of folders to be processed, comprises:

detecting whether the name of each folder in the electronic device conforms to a preset string matching rule respectively;

determining a set of folders corresponding to all detected folder names that conform to the string matching rule, as a set of folders to be processed.

Optionally, before performing a regular expression identification operation on the obtained string corresponding to the path of each folder respectively, the method further comprises:

determining the number N of types of regular expression templates in the regular expression template library that match strings corresponding to paths of folders in the set of folders to be processed;

performing a regular expression identification operation on the obtained string corresponding to the path of each folder respectively, comprises:

when N is less than or equal to a preset first threshold, performing a regular expression identification operation on the obtained string corresponding to the path of each folder respectively.

Optionally, when N is less than or equal to the preset first threshold, before performing a regular expression identification operation on the obtained string corresponding to the path of each folder respectively, the method further comprises:

detecting whether the number of strings corresponding to the paths of the folders contained in the set of folders to be processed that match any type of regular expression template among N types of regular expression templates, is greater than or equal to a preset second threshold;

when N is less than or equal to the preset first threshold, performing a regular expression identification operation on the obtained string corresponding to the path of each folder respectively, comprises:

when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset third threshold;

if so, determining the detected regular expression template as a regular expression template of the folder path corresponding to the string.

Optionally, before performing a regular expression identification operation on the obtained string corresponding to the path of each folder respectively, the method further comprises:

detecting whether the number of strings corresponding to the paths of the folders contained in the set of folders to be processed that match any type of regular expression templates in the regular expression template library, is greater than or equal to a preset fourth threshold;

performing a regular expression identification operation on the obtained string corresponding to the path of each folder respectively, comprises:

when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset fifth threshold;

if so, determining the detected regular expression template as a regular expression template of the folder path corresponding to the string.

In order to achieve the purposes mentioned above, an embodiment of the present invention discloses a method for folder cleaning, applied to an electronic device, wherein the method comprises:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of the folder path corresponding to the string;

identifying a regular expression of folder path corresponding to the string, based on the determined regular expression template;

matching the identified regular expression with a regular expression in a preset regular expression library for file cleaning;

deleting folders corresponding to the matched regular expressions.

In order to achieve the purposes mentioned above, an embodiment of the present invention discloses a device for folder path identification, applied to electronic devices. The device comprises: a first set determining module, a first string obtaining module, a first detecting module, a first template determining module, and a first regular expression identifying module, wherein

the first set determining module is used for determine a set of folders to be processed containing at least one folder;

the first string obtaining module is used to obtain a string corresponding to the path of each folder in the set of folders to be processed determined by the first set determining module;

the first detecting module is used to detect, for a string corresponding to the path of each folder obtained by the first string obtaining module, whether there is a regular expression template that matches the string in a preset regular expression template library containing at least one regular expression template;

the first template determining module is used to determine the regular expression template detected by the first detecting module as a regular expression template of the folder path corresponding to the string;

the first regular expression identifying module is used to identify a regular expression of the folder path corresponding to the string, based on the regular expression template determined by the first template determining module.

Optionally, the first set determining module is specifically used to:

determine each grade of folders in the electronic device as a set of folders to be processed respectively.

Optionally, the first set determining module is specifically used to:

detect whether the name of each folder in the electronic device conforms to a preset string matching rule, respectively;

determine a set of folders corresponding to all detected folder names that conform to the string matching rule, as a set of folders to be processed.

Optionally, the device further comprises: a type number determining module, wherein,

the type number determining module is used to determine the number N of types of regular expression templates in the regular expression template library that match strings corresponding to the paths of folders in the set of folders to be processed determined by the first set determining module;

the first detecting module is specifically used to:

when the number N of types determined by the type number determining module is less than or equal to a preset first threshold, for the string corresponding to the path of each folder obtained by the first string obtaining module, detect whether there is a regular expression template matching the string in the preset regular expression template library.

Optionally, the device further comprises: a second detecting module,

the second detecting module is used to detect whether the number of strings corresponding to the paths of the folders contained in the set of folders to be processed determined by the first set determining module that match any type of regular expression template among the N types of regular expression templates determined by the type number determining module, is greater than or equal to a preset second threshold;

the first detecting module is specifically used to:

when the number N of types determined by the type number determining module is less than or equal to the preset first threshold, and the number of strings, detected by the second detecting module, corresponding to the paths of the folders contained in the set of folders to be processed determined by the first set determining module that match any type of regular expression template among the N types of regular expression templates determined by the type number determining module is greater than or equal to the preset second threshold, for the string corresponding to the path of each folder obtained by the first string obtaining module, detect whether there is a regular expression template matching the string in the preset regular expression template library;

the first template determining module comprises a first judging sub-module and a first template determining sub-module, wherein,

the first judging sub-module is used to judge whether the number of strings corresponding to the paths of the folders in the set of folders to be processed that match the regular expression templates detected by the first detecting module, is greater than or equal to a preset third threshold;

the first template determining sub-module is used to determine the regular expression template detected by the first detecting module as a regular expression template of the folder path corresponding to the string when the judgment result from the first judging sub-module is YES.

Optionally, the device further comprises: a third detecting module,

the third detecting module is used to detect whether the number of strings corresponding to the paths of the folders contained in the set of folders to be processed determined by the first set determining module that match any one of the regular expression templates in the regular expression template library, is greater than or equal to a preset fourth threshold;

the first detecting module is specifically used to:

when the number of strings, detected by the third detecting module, corresponding to the paths of the folders contained in the set of folders to be processed determined by the first set determining module that match any type of regular expression templates in the regular expression template library, is greater than or equal to the preset fourth threshold, for the string corresponding to the path of each folder obtained by the first string obtaining module, detect whether there is a regular expression template matching the string in the preset regular expression template library;

the second template determining module comprises a second judging sub-module and a second template determining sub-module, wherein,

the second judging sub-module is used to judge whether the number of strings corresponding to the paths of the folders in the set of folders to be processed determined by the first set determining module that match the regular expression templates detected by the first detecting module, is greater than or equal to a preset fifth threshold;

the second template determining sub-module is used to determine the regular expression template detected by the first detecting module as a regular expression template of the folder path corresponding to the string when the judgment result from the second judging sub-module is YES.

In order to achieve the purposes mentioned above, an embodiment of the present invention discloses a device for folder path identification, applied to electronic devices. The device comprises: a second set determining module, a second string obtaining module, a fourth detecting module, a second template determining module, a second regular expression identifying module, a matching module, and a deleting module, wherein,

the second set determining module is used to determine a set of folders to be processed containing at least one folder;

the second string obtaining module is used to obtain a string corresponding to the path of each folder in the set of folders to be processed determined by the second set determining module;

the fourth detecting module is used to detect, for the string corresponding to the path of each folder obtained by the second string obtaining module, whether there is a regular expression template that matches the string in a preset regular expression template library containing at least one regular expression template;

the second template determining module is used to determine the regular expression template detected by the fourth detecting module as a regular expression template of the folder path corresponding to the string;

the second regular expression identifying module is used to identify a regular expression of the folder path corresponding to the string, based on the regular expression template determined by the second template determining module;

the matching module is used to match the regular expression identified by the second regular expression identifying module with a regular expression in a preset regular expression library for folder cleaning;

the deleting module is used to delete folders corresponding to the regular expression matched by the matching module.

In order to achieve the purposes mentioned above, an embodiment of the present invention further provides an electronic device, comprising a processor, a memory, a communication interface, and a bus.

The processor, the memory and the communication interface are connected and communicate with each other via the bus;

the memory stores executable code;

and the processor executes a program corresponding to the executable code by reading the executable code stored in the memory for implementing any of the methods for folder path identification provided by embodiments of the present invention.

In order to achieve the purposes mentioned above, an embodiment of the present invention further provides a storage medium for storing executable code, the executable code is used to implement any of the methods for folder path identification provided by the embodiments of the present invention.

In order to achieve the purposes mentioned above, an embodiment of the present invention further provides executable code for implementing any of the methods for folder path identification provided by the embodiments of the present invention.

In order to achieve the purposes mentioned above, an embodiment of the present invention further provides an electronic device, comprising:

a processor, a memory, a communication interface, and a bus.

The processor, the memory and the communication interface are connected and communicate with each other via the bus;

the memory stores executable code;

and the processor executes a program corresponding to the executable code by reading the executable code stored in the memory for implementing any of the methods for folder cleaning provided by embodiments of the present invention.

In order to achieve the purposes mentioned above, an embodiment of the present invention further provides a storage medium for storing executable code, the executable code is used to implement any of the methods for folder cleaning provided by the embodiments of the present invention.

In order to achieve the purposes mentioned above, an embodiment of the present invention further provides executable code for implementing any of the methods for folder cleaning provided by the embodiments of the present invention.

As can be seen from the above technical solutions, the embodiments of the present invention provide a method and a device for folder path identification and folder cleaning, which are applied to electronic devices. The method for folder path identification comprises: determining a set of folders to be processed; obtaining a string corresponding to the path of each folder contained in the set of folders to be processed; for the obtained string corresponding to the path of each folder, performing a regular expression identification operation respectively, wherein, the performing a regular expression identification operation comprises: detecting whether there is a regular expression template matching the string in a preset regular expression template library; if so, determining the detected regular expression template as a regular expression template of folder path corresponding to the string; determining a regular expression of the folder path corresponding to the string based on the determined regular expression template. The technical solutions provided by the embodiments of the present invention can automatically instead of manually identify a regular expression corresponding to folder path to achieve automatic identification of folder path and folder cleaning in electronic devices, improving the efficiency of folder path identification in electronic devices and the efficiency of folder cleaning.

### BRIEF DESCRIPTION OF THE DRAWINGS

In order to explain the technical solutions of embodiments of the present invention and of the prior art, a simple introduction of the drawings required in the description of the embodiments of the present invention and of the prior art will be given. Obviously, the drawings described below are just for some embodiments of the present invention and other drawings may be obtained by those of ordinary skill in the art without any creative efforts based on these drawings.

FIG. 1 is a first schematic flow diagram of the method for folder path identification provided by an embodiment of the present invention;

FIG. 2 is a second schematic flow diagram of the method for folder path identification provided by an embodiment of the present invention;

FIG. 3 is a third schematic flow diagram of the method for folder path identification provided by an embodiment of the present invention;

FIG. 4 is a fourth schematic flow diagram of the method for folder path identification provided by an embodiment of the present invention;

FIG. 5 is a schematic flow diagram of the method for folder cleaning provided by an embodiment of the present invention;

FIG. 6 is a first schematic structural diagram of the device for folder path identification provided by an embodiment of the present invention;

FIG. 7 is a second schematic structural diagram of the device for folder path identification provided by an embodiment of the present invention;

FIG. 8 is a third schematic structural diagram of the device for folder path identification provided by an embodiment of the present invention;

FIG. 9 is a fourth schematic structural diagram of the device for folder path identification provided by an embodiment of the present invention;

FIG. 10 is a structural schematic diagram of the device for folder cleaning provided by an embodiment of the present invention.

### DETAILED DESCRIPTION

The technical solutions of the present invention will be described in detail with reference to the drawings of embodiments of the present invention. Obviously, the embodiments described are merely some of the embodiments of the present invention, and not all of the embodiments. All other embodiments obtained by those of ordinary skill in the art based on the embodiments of the present invention without any creative efforts are within the scope of the present invention.

It is to be noted that the embodiments of the present application are preferably applicable to electronic devices such as electronic devices installed with an IOS operating system (IOS is a handheld device operating system developed by Apple Inc.) or an Android operating system (Android system is a Linux-based free and open source code operating system), or a Windows Phone operating system (Windows Phone is a mobile phone operating system released by Microsoft Inc.), and of course it also applicable to other electronic devices, to which the present application is not limited.

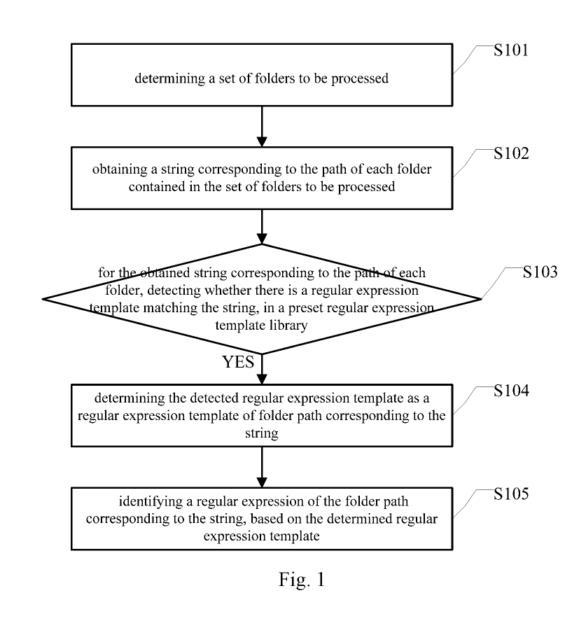

FIG. 1 is a first schematic flow diagram of the method for folder path identification provided by an embodiment of the present invention, wherein the method may comprise:

S101: determining a set of folders to be processed;

wherein the set of folders to be processed contains at least one folder;

S102: obtaining a string corresponding to the path of each folder contained in the set of folders to be processed;

S103: for the obtained string corresponding to the path of each folder, detecting whether there is a regular expression template matching the string, in a preset regular expression template library; If YES, executing S104;
wherein the preset regular expression template library contains at least one regular expression template;

S104: determining the detected regular expression template as a regular expression template of folder path corresponding to the string;

S105: identifying a regular expression of the folder path corresponding to the string, based on the determined regular expression template.

Specifically, in practical application, all folders in the electronic device can be determined as a set of folders to be processed. Each grade of folders in the electronic device can also be determined as a set of folders to be processed, respectively. For example, if there are 20 grades of folders in the electronic device, the first-grade folders, second-grade folders, . . . , and twentieth-grade folders are determined as a set of folders to be processed respectively.

In practical application, for randomly generated folders, the length of the string corresponding to the name of a randomly generated folder is longer. Thus, it is also possible to detect whether the name of each folder in the electronic device conforms to a preset string matching rule, respectively. The set of the folders corresponding to all detected folder names conforming to the string matching rule are determined as the set of folders to be processed. For example, the preset string matching rule is that the number of characters in the string corresponding to a folder name is greater than or equal to 15, then detect whether the number of characters in the string corresponding to the name of each folder in the electronic device is greater than or equal to 15, respectively; determine all the folders whose folder name corresponds to a string in which the number of characters is greater than or equal to 15 as randomly generated folders, and determine the randomly generated folders as a set of folders to be processed.

For example, the set of folders to be processed is a first-grade folder containing 10 folders in the electronic device, and the names of the 10 folders are: Android, bluetooth, DCIM, Download, Movies, Music, Photos, zijizhaopian, 201501010805, and 201501081uzhi. Strings corresponding to the paths of the 10 folders are: “/Android”, “/bluetooth”, “/DCIM”, “/Download”, “/Movies”, “/Music”, “/Photos”, “/zijizhaopian”, “/201501010805”, and “/201501081uzhi”.

Assuming that a preset regular expression template library contains at least 7 regular expression templates, which are:

[0-9] {s %}, s % represents the length of a string, used to identify strings containing only numbers;

[a-z] {s %}, s % represents the length of a string, used to identify strings containing only lower case letters;

[A-Z] {s %}, s % represents the length of a string, used to identify strings containing only upper case letters;

[0-9a-z] {s %}, s % represents the length of a string, used to identify strings containing only numbers and lower case letters;

[0-9A-Z] {s %}, s % represents the length of a string, used to identify strings containing only numbers and upper case letters;

[a-zA-Z] {s %}, s % represents the length of a string, used to identify strings containing only lower case letters and upper case letters;

[0-9a-zA-Z] {s %}, s % represents the length of a string, used to identify strings containing only numbers, lower case letters and upper case letters.

For the above ten strings, detect whether there is a regular expression template in the preset regular expression template library that matches the string, respectively; the detected regular expression template is determined as the regular expression template of folder path corresponding to the string; and a regular expression of the folder path corresponding to the string is identified, based on the determined regular expression template.

Take “/Android” in the above ten strings for example, remove the path separator “/” from the string, detect whether there is a regular expression template that matches the string “Android” with path separator removed, the detection result is YES, and the detected regular expression template is [a-zA-Z] {s %}; [a-zA-Z] {s %} is determined as the regular expression template of the folder path “/Android”; the length of the string “Android” is determined as 7 based on [a-zA-Z] {s %}, the regular expression of the file name “Andriod” is identified as “[a-zA-Z] {7} ”, and the regular expression of the folder path “/Android” is then identified as “/[a-zA-Z] {7}”.

The regular expressions are identified one by one, and the regular expression of folder path “/ bluetooth” is “/[a-z] {9}”,

the regular expression of folder path “/DCIM” is “/[A-Z] {4}”,

the regular expression of folder path “/Download” is “/[a-zA-Z] {8}”,

the regular expression of folder path “/Movies” is “/[a-zA-Z] {6}”,

the regular expression of folder path “/Music” is “/[a-zA-Z] {5}”,

the regular expression of folder path “/Photos” is “/[a-zA-Z] {6}”,

the regular expression of folder path “/zijizhaopian” is “/[a-z] {12}”,

the regular expression of folder path “/201501010805” is “/[0-9] {12}”,

the regular expression of folder path 7201501081uzhi″ is “/[0-9a-z] {13}”.

Specifically, in practical application, it can also determiner a regular expression for folder path containing separator(s), which can be: ‘+’, ‘−’, ‘.’, ‘[’, ‘]’, ‘(‘,’)’, ‘{’, ‘}’, ‘̂’, ‘_’, ‘@’, ‘ [symbol] ’, ‘#’, ‘%’, ‘′’,‘;’, ‘$’, ‘=’, ‘˜’, ‘`’, ‘!’, ‘ ’, etc.

It should be noted that the description in connection with the first-grade folders in the electronic device and with the preset regular expression template library containing 7 regular expression templates above is merely a specific example of the present invention and is not intended to limit the scope of the present invention.

With the embodiment shown in FIG. 1, the automatic identification of folder path in an electronic device can be achieved, and the efficiency of identifying folder path in an electronic device is improved.

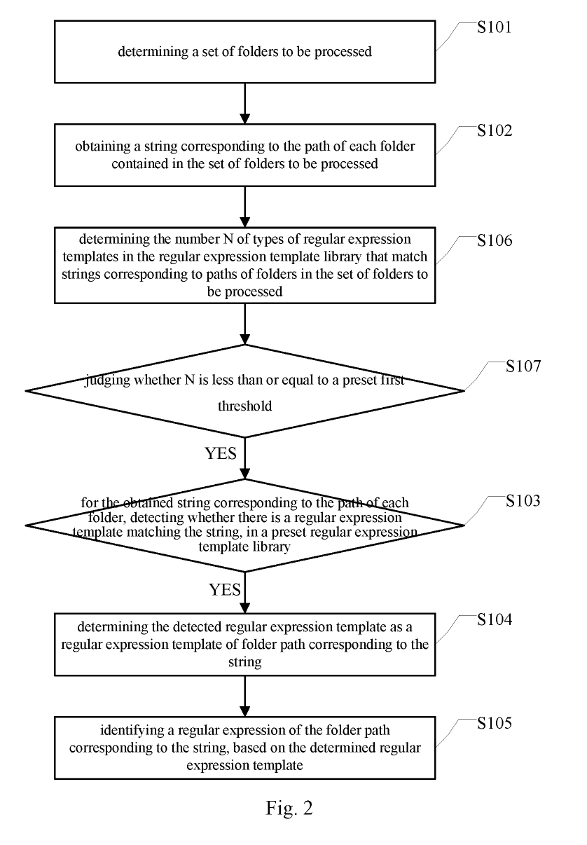

FIG. 2 is a second schematic flow diagram of the method for folder path identification provided by an embodiment of the present invention, on the basis of the embodiment shown in FIG. 1, the following two steps are added in the embodiment shown in FIG. 2:

S106: determining the number N of types of regular expression templates in the regular expression template library that match strings corresponding to paths of folders in the set of folders to be processed;

S107: judging whether N is less than or equal to a preset first threshold; if YES, executing S103.

Specifically, in practical application, if the number of types of regular expression templates in the regular expression template library that match strings corresponding to paths of folders in the set of folders to be processed, is larger than a certain value, it is considered that there is no need to identify the paths of the folders in the set of folders to be processed.

It will be described by taking the first-grade folders in the electronic device and the preset regular expression template library containing 7 regular expression templates as an example.

The number of regular expression templates in the regular expression template library that match strings corresponding to the paths of folders in the set of the first-grade folders is determined as 5. The 5 regular expression templates are [0-9] {s %}, [a-z] {s %}, [A-Z] {s %}, [a-zA-Z] {s %}, [0-9a-z]{s %}. Assuming that the preset first threshold is 6, judge whether the number of types of regular expression templates, which is determined as 5, is less than or equal to 6; and in response to the judgment result of YES, the regular expression identification operation for the obtained string corresponding to the path of each folder respectively will be performed. Assuming that the preset first threshold is 3, judge whether the number of types of regular expression templates is less than or equal to 3; and in response to the judgment result of NO, the regular expression identification operation for the obtained string corresponding to the path of each folder will not be performed.

It should be noted that the description in connection with the first-grade folders in the electronic device and with the preset regular expression template library containing 7 regular expression templates above is merely a specific example of the present invention and is not intended to limit the scope of the present invention.

When the number of types of regular expression templates in a regular expression template library that match strings corresponding to the paths of folders in the set of files to be processed is less than or equal to a certain value, the embodiment of the present application shown in FIG. 2 is applied to enable automatic identification of folder path in electronic devices, improving the efficiency of identifying folder path in electronic devices.

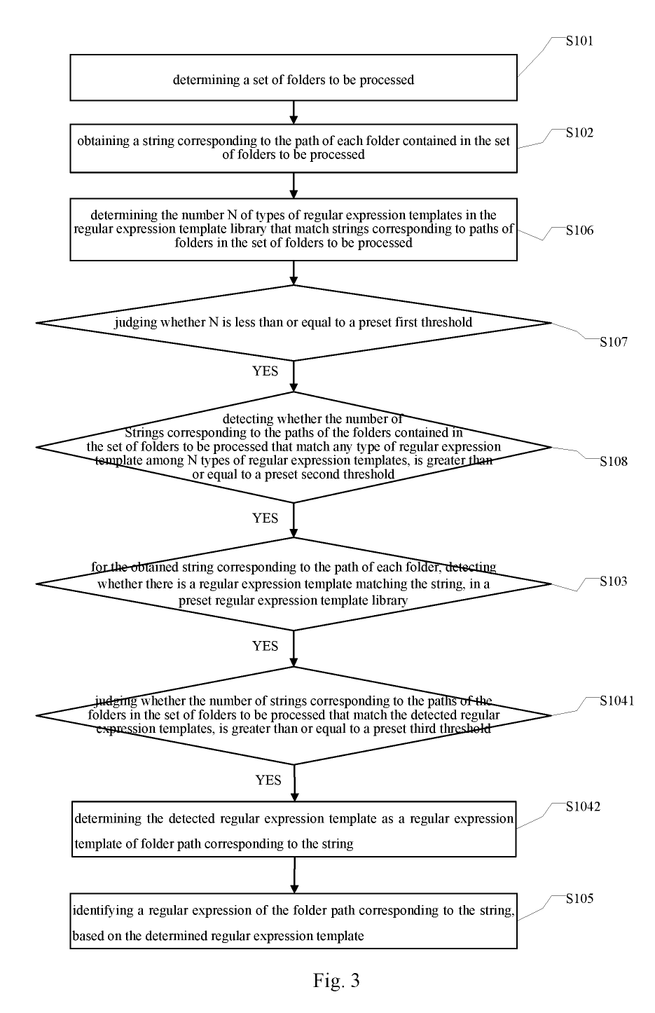

FIG. 3 is a third schematic flow diagram of the method for folder path identification provided by an embodiment of the present invention, on the basis of the embodiment shown in FIG. 2, S108 is added in the embodiment shown in FIG. 3: S108: detecting whether the number of strings corresponding to the paths of the folders contained in the set of folders to be processed that match any type of regular expression template among N types of regular expression templates, is greater than or equal to a preset second threshold; if YES, executing S103.

In this embodiment, S104 may comprise: S1041 and S1042, wherein,

S1041: judging whether the number of strings corresponding to the paths of the folders in the set of folders to be processed that match the detected regular expression templates, is greater than or equal to a preset third threshold; if YES, executing S1042;

S1042: determining the detected regular expression template as a regular expression template of folder path corresponding to the string.

Specifically, in practical application, when the number of types of the determined regular expression templates is less than or equal to a certain value, if the number of strings corresponding to the paths of folders contained in the set of folders to be processed that match all the regular expression templates in the determined regular expression templates, is less than a certain value, it is considered that there is no need to identify paths of folders in the set of folders to be processed.

It will be described by taking the first-grade folders in the electronic device and the preset regular expression template library containing 7 regular expression templates as an example.

In practical application, the preset second threshold may or may not be the same as the preset third threshold. For example, the preset second threshold is 5 and the preset third threshold is 5 too. If the number of strings corresponding to the paths of folders in the set of folders to be processed that match [a-zA-Z] {s %} is equal to 5, the paths of the folders in the set of folders to be processed will be identified.

For the above 10 strings, detect whether there is a regular expression template in the preset regular expression template library that matches the string, respectively; judge whether the number of strings corresponding to the paths of the folders in the set of folders to be processed that match the detected regular expression templates, is greater than or equal to 5; if YES, determine the detected regular expression template as a regular expression template of folder path corresponding to the string; identify a regular expression of the folder path corresponding to the string, based on the determined regular expression template.

Take string “/Android” in the above ten strings for example, remove the path separator “/” from the string, detect whether there is a regular expression template that matches the string “Android” with the path separator removed, and the detection result is YES and the detected regular expression template [a-zA-Z]{s %}; judge whether the number of the strings corresponding to the paths of folders contained in the first-grade folder that match the detected regular expression template [a-zA-Z] {s %}, is greater than or equal to 5, and the judgment result is YES, [a-zA-Z] {s %} is determined as the regular expression template of the folder path “/Android”; the length of the string “Android” is determined as 7, and the regular expression of the folder path “/Android” is then identified as “/[a-zA-Z] {7}” based on [a-zA-Z]{s %}.

Take the string “/bluetooth” as an example, remove the path separator “/” from the string, detect whether there is a regular expression template that matches the string “bluetooth” with the path separator removed, and the detection result is YES and the detected regular expression template [a-z] {s %}; judge whether the number of the strings corresponding to the paths of folders contained in the first-grade folder that match the detected regular expression template [a-z] {s %}, is greater than or equal to 5, and the judgment result is NO, [a-z] {s %} will not be determined as the regular expression template of the folder path “/bluetooth”; and the regular expression of the folder path “/bluetooth” will not be identified.

The identification results of regular expressions for the above ten strings are as follows: the regular expression of folder path “/ Android” is [a-zA-Z] {7}, the regular expression of folder path “/Download” is [a-zA-Z] {8}, the regular expression of folder path “/Movies” is “[a-zA-Z] {6}”, the regular expression of folder path “/Music” is “ [a-zA-Z] {5}”, and the regular expression of folder path “/Photos” is “[a-zA-Z]{6}”.

It should be noted that the description in connection with the first-grade folders in the electronic device and with the preset regular expression template library containing 7 regular expression templates above is merely a specific example of the present invention and is not intended to limit the scope of the present invention.

When the number of types of regular expression templates in the regular expression template library that match the strings corresponding to the paths of folders in the folders to be processed is less than or equal to a certain value, and the number of strings corresponding to the paths of the folders in the set of folders to be processed that matches any type of regular expression template among N types of determined regular expression templates is greater than or equal to a certain value, the embodiment of the present application shown in FIG. 3 is applied to enable automatic identification of folder path in electronic devices, improving the efficiency of identifying folder path in electronic devices.

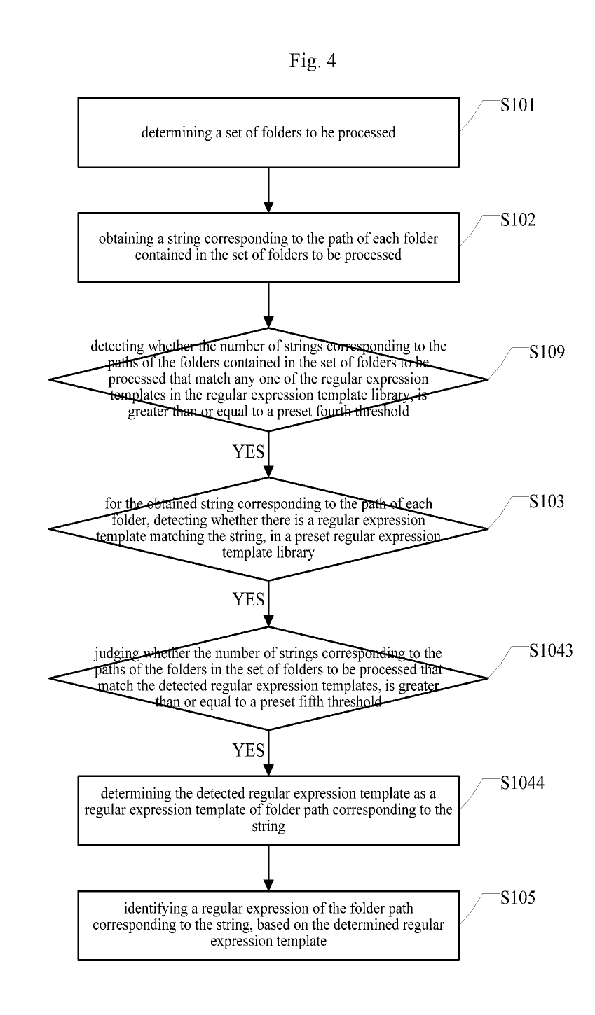

FIG. 4 is a fourth schematic flow diagram of the method for folder path identification provided by an embodiment of the present invention, on the basis of the embodiment shown in FIG. 1, S109 is added in the embodiment shown in FIG. 4, S109: detecting whether the number of strings corresponding to the paths of the folders contained in the set of folders to be processed that match any one of the regular expression templates in the regular expression template library, is greater than or equal to a preset fourth threshold; if YES, executing S103.

In this embodiment, S104 may comprise: S1043 and S1044, wherein,

S1043: judging whether the number of strings corresponding to the paths of the folders in the set of folders to be processed that match the detected regular expression templates, is greater than or equal to a preset fifth threshold; if YES, executing S1044;

S1044: determining the detected regular expression template as a regular expression template of folder path corresponding to the string.

Specifically, in practical application, if the number of strings corresponding to the paths of folders contained in the set of folders to be processed that match all the regular expression templates in the preset regular expression template library is less than a certain value, it is considered that there is no need to identify paths of folders in the set of folders to be processed.

It will be described by taking the first-grade folders in the electronic device and the preset regular expression template library containing 7 regular expression templates as an example.

In practical application, the preset fourth threshold may or may not be the same as the preset fifth threshold. For example, the preset fourth threshold is 5 and the preset fifth threshold is 5 too. If the number of strings corresponding to the paths of folders in the set of folders to be processed that match one type of regular expression template [a-zA-Z] {s %} in the preset regular expression template library is equal to 5, the paths of the folders in the set of folders to be processed will be identified.

For the above 10 strings, detect whether there is a regular expression template in the preset regular expression template library that matches the string, respectively; judge whether the number of strings corresponding to the paths of the folders in the set of folders to be processed that match the detected regular expression templates, is greater than or equal to 5; if YES, determine the detected regular expression template as a regular expression template of folder path corresponding to the string; identify a regular expression of the folder path corresponding to the string, based on the determined regular expression template.

Take “/Android” in the above ten strings for example, remove the path separator “/” from the string, detect whether there is a regular expression template that matches the string “Android” with the path separator removed, and the detection result is YES and the detected regular expression template [a-zA-Z] {s %}; judge whether the number of the strings corresponding to the paths of folders contained in the first-grade folder that match the detected regular expression template [a-zA-Z] {s %}, is greater than or equal to 5, and if the result is YES, [a-zA-Z] {s %} is determined as the regular expression template of the folder path “/Android”; the length of the string “Android” is determined as 7, and the regular expression of the folder path “/Android” is then identified as “/[a-zA-Z] {7}” based on [a-zA-Z] {s %}.

Take “/bluetooth” in the above ten strings for example, remove the path separator “/” from the string, detect whether there is a regular expression template that matches the string “bluetooth” with the path separator removed, and the detection result is YES, and the detected regular expression template [a-z] {s %}; judge whether the number of the strings corresponding to the paths of folders contained in the first-grade folder that match the detected regular expression template [a-z] {s %}, is greater than or equal to 5, and the judgment result is NO, [a-z] {s %} will not be determined as the regular expression template of the folder path “/bluetooth”; and the regular expression of the folder path “/bluetooth” will not be identified.

The identification results of regular expressions for the above ten strings are as follows: the regular expression of folder path “/Android” is “[a-zA-Z] {7}”, the regular expression of folder path “/Download” is “[a-zA-Z] {8}”, the regular expression of folder path “/Movies” is “ [a-zA-Z] {6}”, the regular expression of folder path “/Music” is [a-zA-Z] {5}, and the regular expression of folder path “/Photos” is “[a-zA-Z]{6}”.

It should be noted that the description in connection with the first-grade folders in the electronic device and with the preset regular expression template library containing 7 regular expression templates above is merely a specific example of the present invention and is not intended to limit the scope of the present invention.

When the number of strings corresponding to the paths of the folders in the set of folders to be processed that match any one of the regular expression templates in the preset regular expression template library is greater than or equal to a certain value, the embodiment of the present application shown in FIG. 4 is applied to enable automatic identification of folder path in electronic devices, improving the efficiency of identifying folder path in electronic devices.

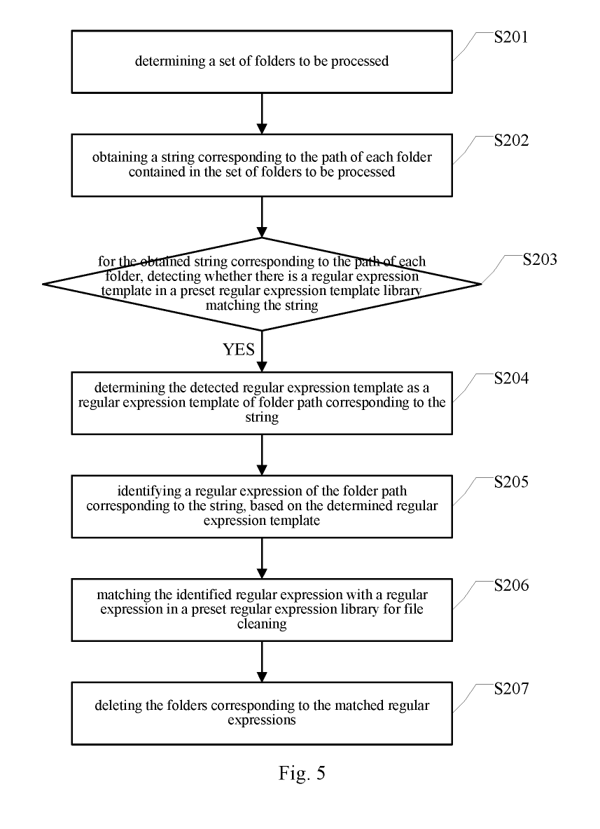

FIG. 5 is a schematic flow diagram of the method for folder cleaning provided by an embodiment of the present invention, which may comprise:

S201: determining a set of folders to be processed; wherein the set of folders to be processed contains at least one folder;

S202: obtaining a string corresponding to the path of each folder contained in the set of folders to be processed;

S203: for the obtained string corresponding to the path of each folder, detecting whether there is a regular expression template in a preset regular expression template library matching the string; if YES, executing S204;

wherein the preset regular expression template library contains at least one regular expression templates;

S204: determining the detected regular expression template as a regular expression template of folder path corresponding to the string;

S205: identifying a regular expression of the folder path corresponding to the string, based on the determined regular expression template;

S206: matching the identified regular expression with a regular expression in a preset regular expression library for file cleaning;

S207: deleting folders corresponding to the matched regular expressions.

Specifically, the steps S201-S205 of this embodiment of the present invention can be referred to the method for folder path identification described above, and will not be described again herein.

Assuming the regular expressions in the preset regular expression library for folder cleaning include: “/[a-zA-Z] {1}”, “/[a-zA-Z] {2}”, “/[a-zA-Z] {3}” . . . “/[a-zA-Z] {30}”.

Assuming that the identification result of the folder path is: the regular expression of the folder path “/Android” is “/[a-zA-Z] {7}, which matches the regular expression “/[a-zA-Z] {7}” in the regular expression library for folder cleaning, the folder “Android” in the first-grade directory corresponding to “/[a-zA-Z] {7}” will be deleted.

Assuming that the identification result of the folder path is: the regular expression of the folder path “/bluetooth” is “/[a-z] {9}, which matches none of the regular expressions in the regular expression library for folder cleaning, the folder “bluetooth” in the first-grade directory corresponding to “/[a-z] {9}” will not be deleted.

The embodiment of the present application shown in FIG. 5 is applied to enable automatic identification of folder path in electronic devices, by matching the identified regular expression with a regular expression in a regular expression library for file cleaning, folders can be cleaned up.

In accordance with the embodiments of methods described above, the embodiment of the present invention also provides a device for folder path identification.

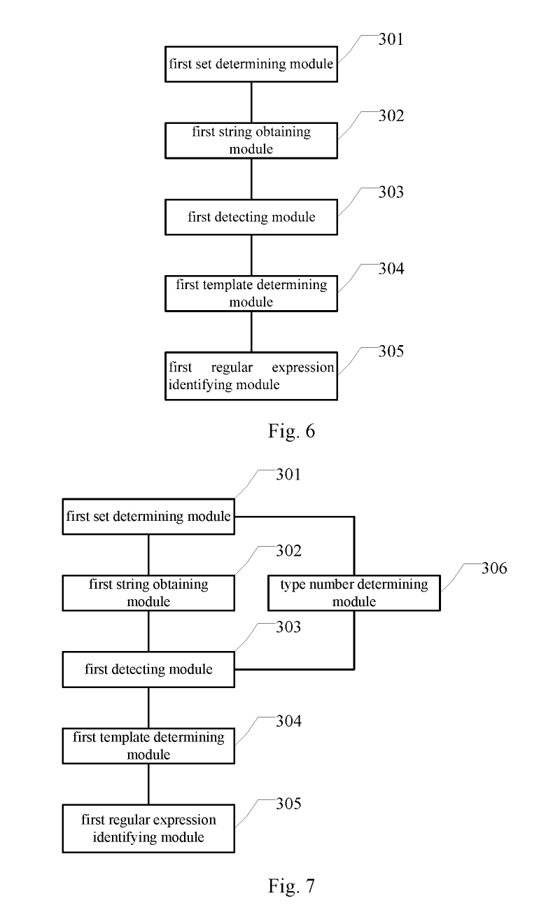

FIG. 6 is a first structural schematic diagram of the device for folder path identification provided by an embodiment of the present invention. The device may comprise: a first set determining module 301, a first string obtaining module 302, a first detecting module 303, a first template determining module 304, and a first regular expression identifying module 305, wherein,

the first set determining module 301 is used to determine a set of folders to be processed containing at least one folder;

the first set determining module 301 of the embodiment of the present invention may be specifically used to:

determine each grade of folders in the electronic device as a set of folders to be processed, respectively.

The first set determining module 301 of the embodiment of the present invention may be specifically used to:

detect whether the name of each folder in the electronic device conforms to a preset string matching rule, respectively;

determine a set of folders corresponding to all detected folder names that conform to the string matching rule, as a set of folders to be processed.

The first string obtaining module 302 is used to obtain a string corresponding to the path of each folder in the set of folders to be processed determined by the first set determining module 301;

the first detecting module 303 is used to detect, for a string corresponding to the path of each folder obtained by the first string obtaining module 302, whether there is a regular expression template that matches the string in a preset regular expression template library containing at least one regular expression template;

the first template determining module 304 is used to determine the regular expression template detected by the first detecting module 303 as a regular expression template of folder path corresponding to the string;

the first regular expression identifying module 305 is used to identify a regular expression of folder path corresponding to the string, based on the regular expression template determined by the first template determining module 304.

With the embodiment shown in FIG. 6, the automatic identification of folder path in an electronic device can be achieved, and the efficiency of identifying folder path in electronic devices is improved.

FIG. 7 is a second structural schematic diagram of the device for folder path identification provided by an embodiment of the present invention, on the basis of the embodiment shown in FIG. 6, a type number determining module 306 is added in the embodiment shown in FIG. 7,

the type number determining module 306 is used to determine the number N of types of regular expression templates in the regular expression template library that match strings corresponding to the paths of folders in the set of folders to be processed determined by the first set determining module 301;

the first detecting module 303 of the embodiment of the present invention may be specifically used to:

when the number N of types determined by the type number determining module 306 is less than or equal to a preset first threshold, for the string corresponding to the path of each folder obtained by the first string obtaining module 302, detect whether there is a regular expression template matching the string in the preset regular expression template library.

When the number of types of regular expression templates in the regular expression template library that match strings corresponding to the paths of folders included in the set of folders to be processed is less than or equal to a certain value, the embodiment of the present application shown in FIG. 7 is applied to enable automatic identification of folder path in electronic devices, improving the efficiency of identifying folder path in electronic devices.

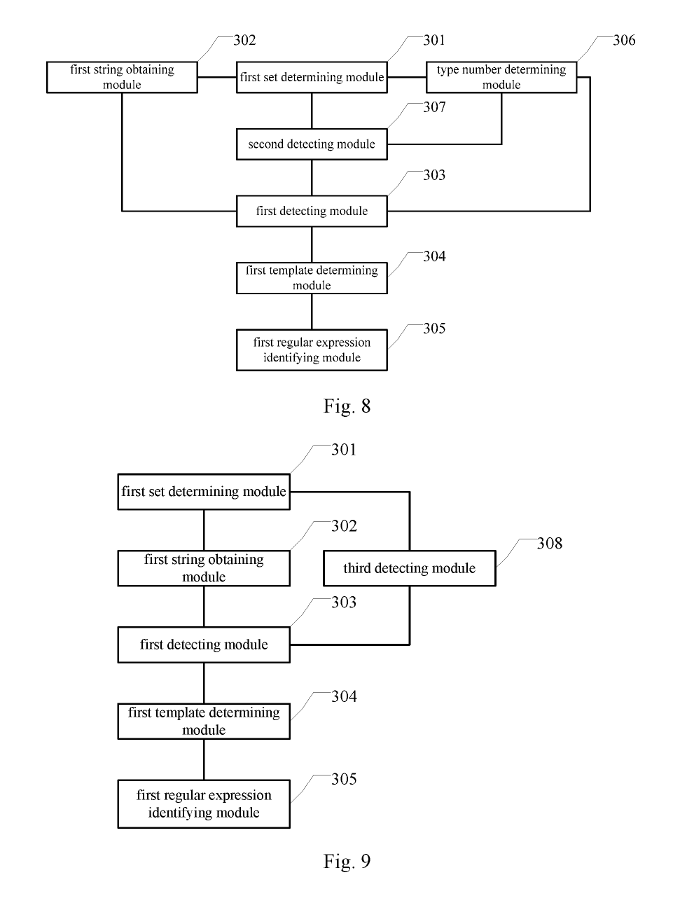

FIG. 8 is a third structural schematic diagram of the device for folder path identification provided by an embodiment of the present invention, on the basis of the embodiment shown in FIG. 7, a second detecting module 307 is added in the embodiment shown in FIG. 8,

the second detecting module 307 is used to detect whether the number of strings corresponding to the paths of the folders contained in the set of folders to be processed determined by the first set determining module 301 that match any type of regular expression template among the N types of regular expression templates determined by the type number determining module 306, is greater than or equal to a preset second threshold;

the first detecting module 303 of the embodiment of the present invention may be specifically used to:

when the number N of types determined by the type number determining module 306 is less than or equal to the preset first threshold, and the number of strings, detected by the second detecting module 307, corresponding to the paths of the folders contained in the set of folders to be processed determined by the first set determining module 301 that match any type of regular expression template among the N types of regular expression templates determined by the type number determining module 306 is greater than or equal to the preset second threshold, for the string corresponding to the path of each folder obtained by the first string obtaining module 302, detect whether there is a regular expression template matching the string in the preset regular expression template library.

The first template determining module 304 of the embodiment of the present invention may comprise a first judging sub-module and a first template determining sub-module (not shown in figures), wherein,

the first judging sub-module is used to judge whether the number of strings corresponding to the paths of the folders in the set of folders to be processed that match the regular expression templates detected by the first detecting module 303, is greater than or equal to a preset third threshold;

the first template determining sub-module is used to determine the regular expression template detected by the first detecting module 303 as a regular expression template of the path of the folder corresponding to the string, when the judgment result from the first judging sub-module is YES.

In practical application, the preset second threshold may or may not be the same as the preset third threshold.

When the number of types of regular expression templates in a regular expression template library that match strings corresponding to the paths of folders in the set of folders to be processed is less than or equal to a certain value, and the number of strings which correspond to the paths of folders in the set of folders to be processed that match any type of regular expression template among the N types of regular expression templates is greater than or equal to a certain value, the embodiment of the present application shown in FIG. 8 is applied to enable automatic identification of folder path in electronic devices, improving the efficiency of identifying folder path in electronic devices.

FIG. 9 is a fourth structural schematic diagram of the device for folder path identification provided by an embodiment of the present invention, on the basis of the embodiment shown in FIG. 6, a third detecting module 309 is added in the embodiment shown in FIG. 9,

the third detecting module 309 is used to detect whether the number of strings corresponding to the paths of the folders contained in the set of folders to be processed determined by the first set determining module 301 that match any one of the regular expression templates in the regular expression template library, is greater than or equal to a preset fourth threshold;

the first detecting module 303 of the embodiment of the present invention may be specifically used to:

when the number of strings, detected by the third detecting module 309, corresponding to the paths of the folders contained in the set of folders to be processed determined by the first set determining module 301 that match any type of regular expression templates in the regular expression template library, is greater than or equal to the preset fourth threshold, for the string corresponding to the path of each folder obtained by the first string obtaining module 302, detect whether there is a regular expression template matching the string in the preset regular expression template library.

The first template determining module 304 of the embodiment of the present invention may comprise a second judging sub-module and a second template determining sub-module (not shown in figures), wherein,

the second judging sub-module is used to judge whether the number of strings corresponding to the paths of the folders in the set of folders to be processed determined by the first set determining module 301 that match the regular expression templates detected by the first detecting module 303, is greater than or equal to a preset fifth threshold;

the second template determining sub-module is used to determine the regular expression template detected by the first detecting module 303 as a regular expression template of folder path corresponding to the string, when the judgment result from the second judging sub-module is YES.

In practical application, the preset fourth threshold may or may not be the same as the preset fifth threshold.

When the number of strings corresponding to the paths of the folders in the set of folders to be processed that match any type of the regular expression templates in the preset regular expression template library is greater than or equal to a certain value, the embodiment of the present invention shown in FIG. 9 is applied to enable automatic identification of folder path in electronic devices, improving the efficiency of identifying folder path in electronic devices.

In accordance with the embodiments of methods described above, the embodiment of the present invention also provides a device for folder cleaning.

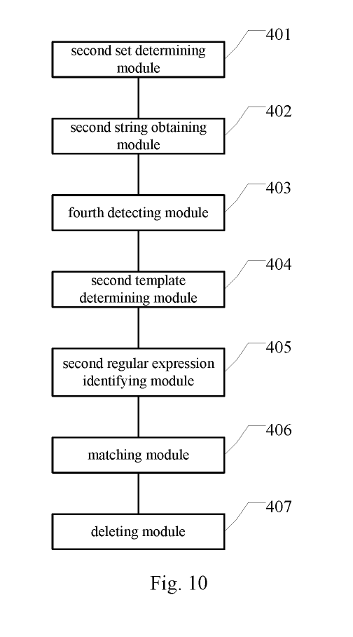

FIG. 10 is a structural schematic diagram of the device for folder cleaning provided by an embodiment of the present invention. The device may comprise: a second set determining module 401, a second string obtaining module 402, a fourth detecting module 403, a second template determining module 404, a second regular expression identifying module 405, a matching module 406, and a deleting module 407, wherein,

the second set determining module 401 is used to determine a set of folders to be processed containing at least one folder;

the second string obtaining module 402 is used to obtain a string corresponding to the path of each folder in the set of folders to be processed determined by the second set determining module 401;

the fourth detecting module 403 is used to detect, for the string corresponding to the path of each folder obtained by the second string obtaining module 402, whether there is a regular expression template that matches the string in a preset regular expression template library containing at least one regular expression template;

the second template determining module 404 is used to determine the regular expression template detected by the fourth detecting module 403 as a regular expression template of folder path corresponding to the string;

the second regular expression identifying module 405 is used to identify a regular expression of the folder path corresponding to the string, based on the regular expression template determined by the second template determining module 404;

the matching module 406 is used to match the regular expression identified by the second regular expression identifying module 406 with a regular expression in a preset regular expression library for folder cleaning;

the deleting module 407 is used to delete folders corresponding to the regular expressions matched by the matching module 406.

With the embodiment of the present invention shown in FIG. 10, the automatic identification of folder path in an electronic device is achieved, and a folder can be cleaned up by matching the identified regular expression template with those in the regular expression library for folder cleaning.

In addition, an embodiment of the present invention provides an electronic device, which may comprise a processor, a memory, a communication interface, and a bus.

The processor, the memory and the communication interface are connected and communicated with each other via the bus;

the memory stores executable code;

and the processor executes a program corresponding to the executable code by reading the executable code stored in the memory for implementing the method for folder path identification provided by embodiments of the present invention; wherein the method for folder path identification provided by the embodiment of the present invention may comprise the steps:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of folder path corresponding to the string;

identifying a regular expression of the folder path corresponding to the string, based on the determined regular expression template.

The determining a set of folders to be processed, comprises:

determining each grade of folders in the electronic device as a set of folders to be processed respectively.

The determining a set of folders to be processed, comprises:

detecting whether the name of each folder in the electronic device conforms to a preset string matching rule respectively;

determining a set of folders corresponding to all detected folder names that conform to the string matching rule, as a set of folders to be processed.

Wherein, before performing a regular expression identification operation on the obtained string corresponding to the path of each folder respectively, the method further comprises:

determining the number N of types of regular expression templates in the regular expression template library that match strings corresponding to paths of folders in the set of folders to be processed;

performing a regular expression identification operation on the obtained string corresponding to the path of each folder respectively, comprises:

when N is less than or equal to a preset first threshold, performing a regular expression identification operation on the obtained string corresponding to the path of each folder respectively.

Wherein, when N is less than or equal to the preset first threshold, before performing a regular expression identification operation on the obtained string corresponding to the path of each folder respectively, further comprises:

detecting whether the number of strings corresponding to the paths of the folders contained in the set of folders to be processed that match any type of regular expression template among N types of regular expression templates, is greater than or equal to a preset second threshold;

when N is less than or equal to the preset first threshold, performing a regular expression identification operation on the obtained string corresponding to the path of each folder respectively, comprises:

when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset third threshold;

if so, determining the detected regular expression template as a regular expression template of the folder path corresponding to the string.

Wherein before performing a regular expression identification operation on the obtained string corresponding to the path of each folder respectively, the method further comprises:

detecting whether the number of strings corresponding to the paths of the folders contained in the set of folders to be processed that match any type of regular expression templates in the regular expression template library, is greater than or equal to a preset fourth threshold;

performing a regular expression identification operation on the obtained string corresponding to the path of each folder respectively, comprises:

when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset fifth threshold;

if so, determining the detected regular expression template as a regular expression template of the folder path corresponding to the string.

In addition, an embodiment of the present invention also provides a storage medium for storing executable code, the executable code is used to implement the method for folder path identification provided by the embodiments of the present invention; wherein the method for folder path identification provided by the embodiment of the present invention may comprise:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of folder path corresponding to the string;

identifying a regular expression of the folder path corresponding to the string, based on the determined regular expression template.

Wherein, the determining a set of folders to be processed, comprises:

determining each grade of folders in the electronic device as a set of folders to be processed respectively.

Wherein, determining a set of folders to be processed, comprises:

detecting whether the name of each folder in the electronic device conforms to a preset string matching rule respectively;

determining a set of folders corresponding to all detected folder names that conform to the string matching rule, as a set of folders to be processed.

Wherein before performing a regular expression identification operation on the obtained string corresponding to the path of each folder respectively, further comprises:

determining the number N of types of regular expression templates in the regular expression template library that match strings corresponding to paths of folders in the set of folders to be processed;

performing a regular expression identification operation on the obtained string corresponding to the path of each folder respectively, comprises:

when N is less than or equal to a preset first threshold, performing a regular expression identification operation on the obtained string corresponding to the path of each folder respectively.

Wherein, when N is less than or equal to the preset first threshold, before performing a regular expression identification operation on the obtained string corresponding to the path of each folder respectively, further comprises:

detecting whether the number of strings corresponding to the paths of the folders contained in the set of folders to be processed that match any type of regular expression template among N types of regular expression templates, is greater than or equal to a preset second threshold;

when N is less than or equal to the preset first threshold, performing a regular expression identification operation on the obtained string corresponding to the path of each folder respectively, comprises:

when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset third threshold;

if so, determining the detected regular expression template as a regular expression template of the folder path corresponding to the string.

Wherein before performing a regular expression identification operation on the obtained string corresponding to the path of each folder respectively, further comprises:

detecting whether the number of strings corresponding to the paths of the folders contained in the set of folders to be processed that match any type of regular expression templates in the regular expression template library, is greater than or equal to a preset fourth threshold;

performing a regular expression identification operation on the obtained string corresponding to the path of each folder respectively, comprises:

when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset fifth threshold;

if so, determining the detected regular expression template as a regular expression template of the folder path corresponding to the string.

Moreover, an embodiment of the present invention also provides executable codes for implement the method for folder path identification provided by the embodiments of the present invention; wherein the method for folder path identification provided by the embodiment of the present invention may comprise the steps:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of folder path corresponding to the string;

identifying a regular expression of the folder path corresponding to the string, based on the determined regular expression template.

Determining a set of folders to be processed, comprises:

determining each grade of folders in the electronic device as a set of folders to be processed respectively.

Determining a set of folders to be processed, comprises:

detecting whether the name of each folder in the electronic device conforms to a preset string matching rule respectively;

determining a set of folders corresponding to all detected folder names that conform to the string matching rule, as a set of folders to be processed.

Wherein, before performing a regular expression identification operation on the obtained string corresponding to the path of each folder respectively, the method further comprises:

determining the number N of types of regular expression templates in the regular expression template library that match strings corresponding to paths of folders in the set of folders to be processed;

performing a regular expression identification operation on the obtained string corresponding to the path of each folder respectively, comprises:

when N is less than or equal to a preset first threshold, performing a regular expression identification operation on the obtained string corresponding to the path of each folder respectively.

Wherein, when N is less than or equal to the preset first threshold, before performing a regular expression identification operation on the obtained string corresponding to the path of each folder respectively, the method further comprises:

detecting whether the number of strings corresponding to the paths of the folders contained in the set of folders to be processed that match any type of regular expression template among N types of regular expression templates, is greater than or equal to a preset second threshold;

when N is less than or equal to the preset first threshold, performing a regular expression identification operation on the obtained string corresponding to the path of each folder respectively, comprises:

when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset third threshold;

if so, determining the detected regular expression template as a regular expression template of the folder path corresponding to the string.

Wherein before performing a regular expression identification operation on the obtained string corresponding to the path of each folder respectively, the method further comprises:

detecting whether the number of strings corresponding to the paths of the folders contained in the set of folders to be processed that match any type of regular expression templates in the regular expression template library, is greater than or equal to a preset fourth threshold;

performing a regular expression identification operation on the obtained string corresponding to the path of each folder respectively, comprises:

when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset fifth threshold;

if so, determining the detected regular expression template as a regular expression template of the folder path corresponding to the string.

In addition, an embodiment of the present invention also provides a storage medium for storing executable code; the executable code is used to implement the method for folder path identification provided by the embodiments of the present invention; wherein the method for folder path identification provided by the embodiment of the present invention may comprise:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of folder path corresponding to the string;

identifying a regular expression of the folder path corresponding to the string, based on the determined regular expression template.

Wherein, determining a set of folders to be processed, comprises:

determining each grade of folders in the electronic device as a set of folders to be processed respectively.

Wherein, determining a set of folders to be processed, comprises:

detecting whether the name of each folder in the electronic device conforms to a preset string matching rule respectively;

determining a set of folders corresponding to all detected folder names that conform to the string matching rule, as a set of folders to be processed.

Wherein before performing a regular expression identification operation on the obtained string corresponding to the path of each folder respectively, further comprises:

determining the number N of types of regular expression templates in the regular expression template library that match strings corresponding to paths of folders in the set of folders to be processed;

performing a regular expression identification operation on the obtained string corresponding to the path of each folder respectively, comprises:

when N is less than or equal to a preset first threshold, performing a regular expression identification operation on the obtained string corresponding to the path of each folder respectively.

Wherein, when N is less than or equal to the preset first threshold, before performing a regular expression identification operation on the obtained string corresponding to the path of each folder respectively, the method further comprises:

detecting whether the number of strings corresponding to the paths of the folders contained in the set of folders to be processed that match any type of regular expression template among N types of regular expression templates, is greater than or equal to a preset second threshold;

when N is less than or equal to the preset first threshold, performing a regular expression identification operation on the obtained string corresponding to the path of each folder respectively, comprises:

when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset third threshold;

if so, determining the detected regular expression template as a regular expression template of the folder path corresponding to the string.

Wherein before performing a regular expression identification operation on the obtained string corresponding to the path of each folder respectively, the method further comprises:

detecting whether the number of strings corresponding to the paths of the folders contained in the set of folders to be processed that match any type of regular expression templates in the regular expression template library, is greater than or equal to a preset fourth threshold;

performing a regular expression identification operation on the obtained string corresponding to the path of each folder respectively, comprises:

when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;

determining the detected regular expression template as a regular expression template of the folder path corresponding to the string, comprises:

judging whether the number of strings corresponding to the paths of the folders in the set of folders to be processed that match the detected regular expression templates, is greater than or equal to a preset fifth threshold;

if so, determining the detected regular expression template as a regular expression template of the folder path corresponding to the string.

Moreover, an embodiment of the present invention provides an electronic device, which may comprise a processor, a memory, a communication interface, and a bus.

The processor, the memory and the communication interface are connected and communicate with each other via the bus;

the memory stores executable codes;

and the processor executes a program corresponding to the executable code by reading the executable code stored in the memory for implementing the method for folder cleaning provided by embodiments of the present invention; wherein the method for folder cleaning provided by the embodiment of the present invention may comprise:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of the folder path corresponding to the string;

identifying a regular expression of folder path corresponding to the string, based on the determined regular expression template;

matching the identified regular expression with a regular expression in a preset regular expression library for file cleaning;

deleting folders corresponding to the matched regular expressions.

Moreover, an embodiment of the present invention also provides a storage medium for storing executable code, the executable code is used to implement the method for folder cleaning provided by the embodiments of the present invention; wherein the method for folder cleaning provided by the embodiment of the present invention may comprise:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of the folder path corresponding to the string;

identifying a regular expression of folder path corresponding to the string, based on the determined regular expression template;

matching the identified regular expression with a regular expression in a preset regular expression library for file cleaning;

deleting folders corresponding to the matched regular expressions.

Moreover, an embodiment of the present invention also provides executable code for implementing the method for folder cleaning provided by the embodiments of the present invention; wherein the method for folder cleaning provided by the embodiment of the present invention may comprise the steps:

determining a set of folders to be processed containing at least one folder;

obtaining a string corresponding to the path of each folder contained in the set of folders to be processed;

performing a regular expression identification operation on the obtained string corresponding to the path of each folder respectively, wherein the regular expression identification operation comprises:

detecting whether there is a regular expression template matching the string in a preset regular expression template library containing at least one regular expression template;

if so, determining the detected regular expression template as a regular expression template of the folder path corresponding to the string;

identifying a regular expression of folder path corresponding to the string, based on the determined regular expression template;

matching the identified regular expression with a regular expression in a preset regular expression library for file cleaning;

deleting folders corresponding to the matched regular expressions.

It should be noted that, the relationship terms herein such as “first”, “second” and the like are only used to distinguish one entity or operation from another entity or operation, but do not necessarily require or imply that there is actual relationship or order between these entities or operations. Moreover, the terms “include”, “comprise” or any other variants thereof are intended to cover a non-exclusive inclusion, such that processes, methods, articles, or devices comprising a series of elements comprise not only those elements listed but also those not specifically listed or the elements intrinsic to these processes, methods, articles, or equipment. Without further limitations, elements defined by the sentences “comprise(s) a . . . ” or “include(s) a . . . ” do not exclude that there are other identical elements in the processes, methods, articles, or devices which comprise these elements.

All embodiments in the description are described in a correlated manner, and identical or similar parts in various embodiments can be referred to one another, the description for each embodiment all focuses on the differences with other embodiments. Especially, the embodiments of a device are briefly described and reference can be made to the description of the embodiments of a method for its related contents since the embodiments of the device are substantially similar to those of the method.

It will be understood by those of ordinary skill in the art that all or some of the steps in the method described above may be accomplished by a program to instruct the associated hardware. Said program may be stored in a computer-readable storage medium, such as ROM/RAM, magnetic disks, optical disks, etc.

Embodiments described above are just preferred embodiments of the present invention, and not intended to limit the scope of the present invention. Any modifications, equivalent, improvement or the like within the spirit and principle of the present invention should be included in the scope of the present invention.

1. A method for folder path identification, applied to an electronic device, wherein the method comprises:
determining a set of folders to be processed containing at least one folder;
obtaining a string corresponding to the path of each folder contained in the set of folders to be processed;
performing a regular expression identification operation on the obtained string corresponding to the path of each folder respectively, wherein the regular expression identification operation comprises:
detecting whether there is a regular expression template matching the string in a preset regular expression template library containing at least one regular expression template;
if so, determining the detected regular expression template as a regular expression template of folder path corresponding to the string;
identifying a regular expression of the folder path corresponding to the string based on the determined regular expression template.

2. The method of claim 1, wherein determining a set of folders to be processed comprises:
determining each grade of folders in the electronic device as a set of folders to be processed respectively.

3. The method of claim 1, wherein determining a set of folders to be processed comprises:
detecting whether the name of each folder in the electronic device conforms to a preset string matching rule respectively;
determining a set of folders corresponding to all detected folder names that conform to the string matching rule, as a set of folders to be processed.

4. The method of claim 1, wherein before performing a regular expression identification operation on the obtained string corresponding to the path of each folder respectively, the method further comprises:
determining the number N of types of regular expression templates in the regular expression template library that match strings corresponding to paths of folders in the set of folders to be processed;
performing a regular expression identification operation on the obtained string corresponding to the path of each folder respectively, comprises:
when N is less than or equal to a preset first threshold, performing a regular expression identification operation on the obtained string corresponding to the path of each folder respectively.

5. The method of claim 4, wherein, when N is less than or equal to the preset first threshold, before performing a regular expression identification operation on the obtained string corresponding to the path of each folder respectively, the method further comprises:
detecting whether the number of strings corresponding to the paths of the folders contained in the set of folders to be processed that match any type of regular expression template among N types of regular expression templates, is greater than or equal to a preset second threshold;
when N is less than or equal to the preset first threshold, performing a regular expression identification operation on the obtained string corresponding to the path of each folder respectively, comprises:
when N is less than or equal to the preset first threshold, and the number of strings corresponding to the paths of the folders in the set of folders to be processed that match any type of regular expression template among N types of regular expression templates is greater than or equal to the preset second threshold, performing a regular expression identification operation on the obtained string corresponding to the path of each folder respectively;
determining the detected regular expression template as a regular expression template of the folder path corresponding to the string, comprises:
judging whether the number of strings corresponding to the paths of the folders in the set of folders to be processed that match the detected regular expression templates, is greater than or equal to a preset third threshold;
if so, determining the detected regular expression template as a regular expression template of the folder path corresponding to the string.

6. The method of claim 1, wherein before performing a regular expression identification operation on the obtained string corresponding to the path of each folder respectively, the method further comprises:
detecting whether the number of strings corresponding to the paths of the folders contained in the set of folders to be processed that match any type of regular expression templates in the regular expression template library, is greater than or equal to a preset fourth threshold;
performing a regular expression identification operation on the obtained string corresponding to the path of each folder respectively, comprises:
when the number of strings corresponding to the paths of the folders in the set of folders to be processed that match any of the regular expression templates in the regular expression template library, is greater than or equal to the preset fourth threshold, performing a regular expression identification operation on the obtained string corresponding to the path of each folder respectively;
determining the detected regular expression template as a regular expression template of the folder path corresponding to the string, comprises:
judging whether the number of strings corresponding to the paths of the folders in the set of folders to be processed that match the detected regular expression templates, is greater than or equal to a preset fifth threshold;
if so, determining the detected regular expression template as a regular expression template of the folder path corresponding to the string.

7. A method for folder cleaning, applied to an electronic device, wherein the method comprises:
determining a set of folders to be processed containing at least one folder;
obtaining a string corresponding to the path of each folder contained in the set of folders to be processed;
performing a regular expression identification operation on the obtained string corresponding to the path of each folder respectively, wherein the regular expression identification operation comprises:
detecting whether there is a regular expression template matching the string in a preset regular expression template library containing at least one regular expression template;
if so, determining the detected regular expression template as a regular expression template of the folder path corresponding to the string;
identifying a regular expression of folder path corresponding to the string, based on the determined regular expression template;
matching the identified regular expression with a regular expression in a preset regular expression library for file cleaning;
deleting folders corresponding to the matched regular expressions.

8. A device for folder path identification, applied to an electronic device, wherein the device comprises: a first set determining module, a first string obtaining module, a first detecting module, a first template determining module, and a first regular expression identifying module, wherein,
the first set determining module is used for determine a set of folders to be processed containing at least one folder;
the first string obtaining module is used to obtain a string corresponding to the path of each folder in the set of folders to be processed determined by the first set determining module;
the first detecting module is used to detect, for a string corresponding to the path of each folder obtained by the first string obtaining module, whether there is a regular expression template that matches the string in a preset regular expression template library containing at least one regular expression template;
the first template determining module is used to determine the regular expression template detected by the first detecting module as a regular expression template of the folder path corresponding to the string;
the first regular expression identifying module is used to identify a regular expression of the folder path corresponding to the string, based on the regular expression template determined by the first template determining module.

9. The device of claim 8, wherein the first set determining module is specifically used to:
determine each grade of folders in the electronic device as a set of folders to be processed respectively.

10. The device of claim 8, wherein the first set determining module is specifically used to:
detect whether the name of each folder in the electronic device conforms to a preset string matching rule, respectively;
determine a set of folders corresponding to all detected folder names that conform to the string matching rule, as a set of folders to be processed.

11. The device of claim 8, wherein the device further comprises a type number determining module, wherein,
the type number determining module is used to determine the number N of types of regular expression templates in the regular expression template library that match strings corresponding to the paths of folders in the set of folders to be processed determined by the first set determining module;
the first detecting module is specifically used to:
when the number N of types determined by the type number determining module is less than or equal to a preset first threshold, for the string corresponding to the path of each folder obtained by the first string obtaining module, detect whether there is a regular expression template matching the string in the preset regular expression template library.

12. The device of claim 11, wherein the device further comprises: a second detecting module,
the second detecting module is used to detect whether the number of strings corresponding to the paths of the folders contained in the set of folders to be processed determined by the first set determining module that match any type of regular expression template among the N types of regular expression templates determined by the type number determining module, is greater than or equal to a preset second threshold;
the first detecting module is specifically used to:
when the number N of types determined by the type number determining module is less than or equal to the preset first threshold, and the number of strings, detected by the second detecting module, corresponding to the paths of the folders contained in the set of folders to be processed determined by the first set determining module that match any type of regular expression template among the N types of regular expression templates determined by the type number determining module is greater than or equal to the preset second threshold, for the string corresponding to the path of each folder obtained by the first string obtaining module, detect whether there is a regular expression template matching the string in the preset regular expression template library;
the first template determining module comprises a first judging sub-module and a first template determining sub-module, wherein,
the first judging sub-module is used to judge whether the number of strings corresponding to the paths of the folders in the set of folders to be processed that match the regular expression templates detected by the first detecting module, is greater than or equal to a preset third threshold;
the first template determining sub-module is used to determine the regular expression template detected by the first detecting module as a regular expression template of the folder path corresponding to the string when the judgment result from the first judging sub-module is YES.

13. The device of claim 8, wherein the device further comprises a third detecting module, wherein,
the third detecting module is used to detect whether the number of strings corresponding to the paths of the folders contained in the set of folders to be processed determined by the first set determining module that match any one of the regular expression templates in the regular expression template library, is greater than or equal to a preset fourth threshold;
the first detecting module is specifically used to:
when the number of strings, detected by the third detecting module, corresponding to the paths of the folders contained in the set of folders to be processed determined by the first set determining module that match any type of regular expression templates in the regular expression template library, is greater than or equal to the preset fourth threshold, for the string corresponding to the path of each folder obtained by the first string obtaining module, detect whether there is a regular expression template matching the string in the preset regular expression template library;
the second template determining module comprises a second judging sub-module and a second template determining sub-module, wherein,
the second judging sub-module is used to judge whether the number of strings corresponding to the paths of the folders in the set of folders to be processed determined by the first set determining module that match the regular expression templates detected by the first detecting module, is greater than or equal to a preset fifth threshold;
the second template determining sub-module is used to determine the regular expression template detected by the first detecting module as a regular expression template of the folder path corresponding to the string when the judgment result from the second judging sub-module is YES.

14. (canceled)
